(19) United States
(12) Patent Application Publication
(10) Pub. No.: US 2014/0122076 A1
(43) Pub. Date: May 1, 2014

(54) Voice Command System for Stitchers

(71) Applicant: GAMMILL, INC., West Plains, MO (US)

(72) Inventors: Theodore Stokes, Columbia, MO (US); Joseph W. Bauman, Cabool, MO (US)

(73) Assignee: GAMMILL, INC., West Plains, MO (US)

(21) Appl. No.: 14/063,315

(22) Filed: Oct. 25, 2013

Related U.S. Application Data
(60) Provisional application No. 61/719,167, filed on Oct. 26, 2012.

(51) Int. Cl. G10L 21/06

(52) U.S. Cl. CPC G10L 21/06
USPC 704/246

(57) ABSTRACT

A voice command system for a stitcher includes a tablet device in operative communication with the stitcher; the tablet device further comprising a display screen; a memory; a microprocessor; a communication module; and a microphone; and a speech recognition algorithm operatively communicating with said tablet device. An associated method includes the steps of digitizing a user's spoken command; transmitting the digitized spoken command to the speech recognition algorithm; producing a list of words possibly comprising the spoken command; parsing the list of possible words to identify the spoken command; and initiating execution of the spoken command.

### CROSS REFERENCE

This application claims priority to U.S. Provisional Patent Application Ser. No. 61/719,167, filed Oct. 26, 2012.

### TECHNICAL FIELD OF THE INVENTION

The present invention relates generally to stitching or sewing machines and, more particularly, to a hands-free control system for same.

### BACKGROUND OF THE INVENTION

Stitchers and sewing machines are increasingly complex pieces of machinery that frequently offer multiple modes of operation and varying features for use. Prior art stitchers and sewing machines utilize a variety of control mechanisms to allow a user to select modes of operation and available features and to generally control the machine. These control mechanisms generally include a control panel of some type; in some cases push buttons or a touch screen device.

However, a common feature of the prior art is that user must select the desired mode by hand. This is problematic for some users, particularly when the machine in question is one in which the user must guide the fabric through the machine or guide the machine over the fabric, which generally requires both hands of the user.

Therefore, it would be advantageous to provide a control system for a stitcher or sewing machine that allows for hands-free control of key aspects of the machine.

### SUMMARY OF THE INVENTION

One aspect of the invention generally pertains to a voice command system for a stitcher that allows hands-free control of machine modes and functions by a user.

In accordance with one or more of the above aspects of the invention, there is provided a voice command system for a stitcher that includes a tablet device in operative communication with the stitcher; the tablet device further comprising a display screen; a memory; a microprocessor; a communication module; and a microphone; and a speech recognition algorithm operatively communicating with said tablet device.

In accordance with another aspect, there is provided an associated method that includes the steps of digitizing a user's spoken command; transmitting the digitized spoken command to the speech recognition algorithm; producing a list of words possibly comprising the spoken command; parsing the list of possible words to identify the spoken command; and initiating execution of the spoken command.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a perspective view of a stitcher according to an embodiment of the present system.

FIG. 2 is a schematic view of a control system for a stitcher according an embodiment of the present invention.

FIG. 3 is a flow diagram for the operation of a control system according to an embodiment of the present invention.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

FIG. 1 illustrates a standard long-arm stitcher 10 including a base 12, an arm 14, and a take up lever box 16. Although the present invention is described with respect to a long-arm stitcher, one of ordinary skill in the art would recognize that the present invention is also applicable to standard sewing machines. Moreover, the present invention is capable of operating with both commercial and household long-arm stitchers and sewing machines. The arm 14 is coupled to the base 12 at a back end 18 of the stitcher 10. A first portion 20 of the arm 14 extends upward from the base 12, and a second portion 22 of the arm 14 extends from the first portion 20 substantially parallel to the base 12. The take up lever box 16 is disposed on the arm 14 at a stitching end 24 of the stitcher 10 that is opposite the back end 18. The stitching end 24 of the stitcher 10 forms a workspace 26 where a fabric is stitched by an operator of the stitcher 10. The stitching end includes a needle bar 28 having a needle 30 inserted therein and a hopping foot 32 each extending downward toward a needle plate 34 disposed on the base 12. The needle plate 34 is attached to a square throat plate 36. The throat plate 36 is configured to be removed to provide access to a rotary hook assembly (not shown) positioned within the base 12 below the throat plate 36.

During operation, the needle bar 28 moves up and down thereby moving the needle 30 to form a stitch in the fabric. The needle bar 28 can be adjusted up or down to provide a proper machine timing height. A small hole in the needle plate 34 restricts movement of the thread as the stitch is formed. The hopping foot 32 raises and lowers with the movement of the needle 30 to press and release the fabric as the stitch is formed. The hopping foot 32 is designed to be used with rulers and templates and has a height that can be adjusted for proper stitch formation. A control box 48 is provided to control the operation of the stitcher 10.

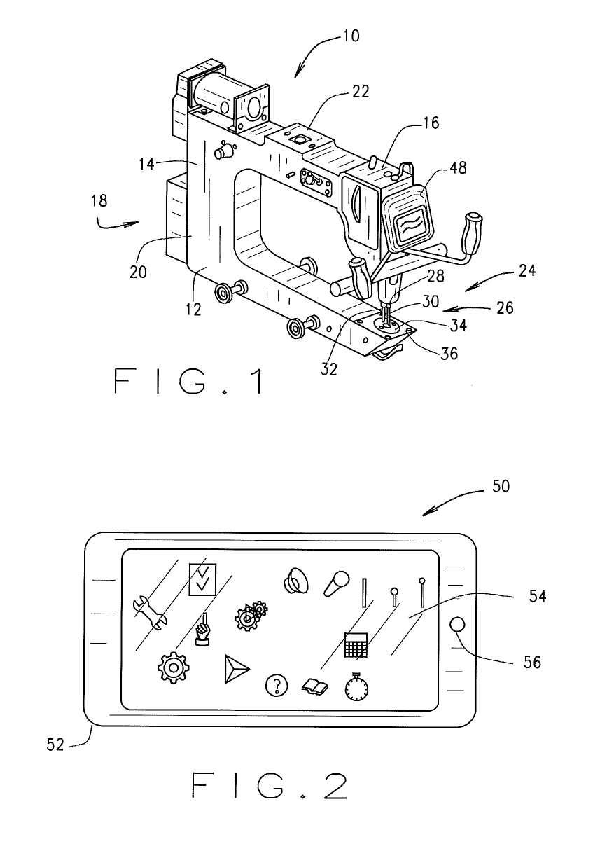

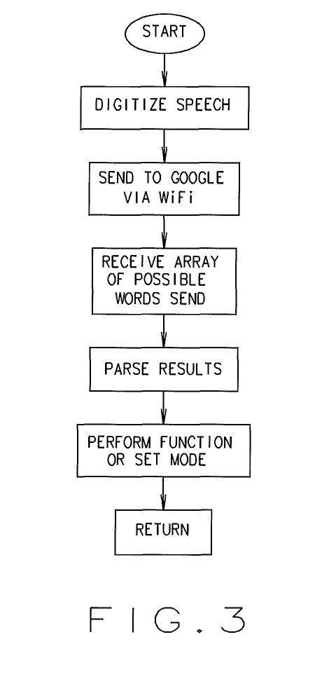

FIG. 2 illustrates a control system for the stitcher 10. The control system includes a tablet device 50 that is in operative communication with the stitcher via a communication module that is hardwired or wireless, for example, Bluetooth or Wi-Fi. In a preferred embodiment, the tablet device 50 is an Android®-based device. The tablet device 50 is provided with a microphone 52 to receive ambient noise, including voice commands from a user. The tablet device 50 is also provided with a screen 54, which may be a touch screen for an alternate mode of command input. The tablet device 50 further has a microprocessor (not shown) for operation of the device 50 and a memory. The tablet device 50 is capable of displaying a series of menus and machine operation options on the screen 54.

The tablet device 50 is programmed to provide hands-free manipulation of the modes of the stitcher 10, as well as requests for functions such as “needle up”, “needle down”, “single stitch”, and others. The tablet device 50 prompts the user to speak a command and then listens for a resulting command from the user. After receiving the command through its microphone 52, the tablet device interprets the voice command. If the tablet device 50 is able to interpret the voice command, the command is executed according to the flow chart in FIG. 3.

First, the device 50 digitizes the voice command. The device 50 transmits the digitized command to a speech recognition algorithm. The algorithm may be resident on the device's processor or memory, or the device may transmit the voice command to a remote system having such an algorithm. In one embodiment, the device 50 utilizes its wireless connection to transmit the voice command to Google's® speech recognition algorithm via the Internet. The speech recognition algorithm converts the digitized speech to a list of words. The speech recognition algorithm provides an array of possible words or phrases spoken. In a preferred embodiment, the array is an ASCII array. The array is then parsed by the device 50 to identify recognized commands. A list of recognized commands is maintained in the memory of the device 50, and the array is compared to this list to find matches.

Once a match is found within the list of recognized commands, the device 50 performs the identified command. The command may be a machine operation mode change or a command to manipulate the machine in some way such as raising or lowering the needle or making a single stitch. Once implementation of the command is initiated in the stitcher 10 by the device 50, it returns to its ready state to receive another command.

The device 50 preferably is capable of interpreting voice commands in a variety of languages. In a preferred embodiment, the device 50 utilizes the voice recognition intent function of the Android API.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. A voice command system for a stitcher, comprising:
a tablet device in operative communication with said stitcher;
said tablet device further comprising:
a display screen;
a memory;
a microprocessor;
a communication module; and
a microphone; and
a speech recognition algorithm operatively communicating with said tablet device.

2. The voice command system for a stitcher as set forth in claim 1, wherein said communication is a wireless communication module.

3. The voice command system for a stitcher as set forth in claim 1, wherein said speech recognition algorithm is stored in said memory of said tablet device.

4. The voice command system for a stitcher as set forth in claim 1, wherein said speech recognition algorithm is accessed by said tablet device via said communication module and a global communication network.

5. The voice command system for a stitcher as set forth in claim 1, wherein said memory further comprises a list of recognized stitcher commands stored within said memory.

6. A method of operating a stitcher by a voice command system, comprising the steps of:
providing a tablet device in operative communication with said stitcher, said tablet device further comprising:
a display screen;
a memory;
a microprocessor;
a communication module; and
a microphone; and
a speech recognition algorithm operatively communicating with said tablet device;
digitizing a user's spoken command received by said microphone;
transmitting said digitized spoken command to said speech recognition algorithm;
producing a list of possible words comprising said spoken command;
parsing said list of possible words to identify said spoken command; and
initiating execution of said spoken command.

7. The method of operating a stitcher by a voice command system as set forth in claim 6, wherein the step of producing a list of possible words comprising said spoken command further comprising providing said list as an ASCII array.

8. The method of operating a stitcher by a voice command system as set forth in claim 6, wherein said speech recognition algorithm is stored in said memory of said tablet device.

9. The method of operating a stitcher by a voice command system as set forth in claim 6, wherein said step of transmitting said digitized spoken command to said speech recognition algorithm further comprises accessing said speech recognition algorithm via said communication module and a global communication network.
